(19) United States
(12) Patent Application Publication
(10) Pub. No.: US 2005/0188214 A1
(43) Pub. Date: Aug. 25, 2005

(54) Authenticatable software modules

(76) Inventors: John S. Worley, Fort Collins, CO (US); Timothy A. Frye, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/785,460

(22) Filed: Feb. 23, 2004

(51) Int. Cl. H04L 9/00

(52) U.S. Cl. 713/187

(57) ABSTRACT

In various embodiments of the present invention, a first software entity, such as a program, routine, library, or module, authenticates a second software entity by extracting an authentication block from memory, validating the extracted authentication block, and comparing a value stored in the authentication block with a computable or pre-computed authentication value in order to authenticate the second software entity. In certain alternative embodiments, a program can authenticate itself at run-time. Additional embodiments of the present invention include methods for constructing and inserting authentication blocks into software entities to facilitate authentication by the authentication methods that represent embodiments of the present invention.

### TECHNICAL FIELD

The present invention is related to computer security and, in particular, to methods and systems that allow a first software entity, such as a program, routine, library, or module, to authenticate a second software entity.

### BACKGROUND OF THE INVENTION

During the past decade, as the use of, and access to, computers have increased in every facet of human activity, computer security has grown to be an extremely vital and important area of research, product development, and service provision. Many recent, high-profile computer crimes and computer-system security breaches have increased public concern with respect to computer-security issues. The constant onslaught of computer viruses communicated to personal and business computers through the Internet has additionally increased public concern.

There are many different approaches to computer security currently employed, and many more are currently being investigated and developed. Various strategies employ physical security, security against unintended, but dangerous flaws and vulnerabilities in software and hardware products provided by code review and code verification, encryption-based securing of electronically communicated information, and many different, highly technical techniques and systems for securing access and operation of computers from unintended users and observers. Unfortunately, although great strides have been made to increase the relative security of computer systems, completely and reliably secure systems remain elusive.

The present invention relates to software authentication, an overview which is next provided, with reference to FIGS. 1A-D. FIG. 1A, employing illustration conventions also employed in FIGS. 1B-D, referenced below, illustrates the basic concept of stored-program execution. FIG. 1A shows a memory 102 and a central processor (“CPU”) 104 within a single-processor computer system, although the points made below with reference to FIGS. 1A-D apply equally well to multi-processor computer systems and to multi-computer distributed computing systems. The memory 102 includes various different memory-resident objects 106-111. These objects may include stored programs and routines, data structures, such as stacks, variables, arrays, and other types of data structures, operating-system components, and other stored information. Although memory is shown in FIG. 1A as a single entity, the memory in a computer system may be distributed over various caches, random-access memories, read-only memories, and mass-storage devices from which information in the volatile memory components may be initially obtained and refreshed. Moreover, stored entities within memory may be fragmented and dispersed in non-contiguous blocks, rather than being stored in a contiguous set of computer words, as indicated in FIG. 1A. The simplified, high-level description shown in FIG. 1A is, however, adequate for purposes of describing software authentication,

Information may be transferred to memory directly by the central processor 112, from external sources, such as mass-storage devices, communications links, and peripheral components under processor control 114, and, in many systems, directly from outside sources 116 without central processor intervention. Similarly, information can be extracted from memory directly by the central processor 118, by external entities under central processor control 120, and in many systems, by external entities without direct central processor supervision 122.

In the vast majority of modern computer systems, stored programs are more-or-less sequentially executed, instruction-by-instruction, by a processor. FIG. 1B shows a first instruction 124 within a stored program 106 being fetched 126 by the processor 104 for execution. Each different computer architecture provides a different set of instruction types. Instructions may specify data movement, arithmetic and logical operations, control of various parameters and characteristics of computer operation, and other direct, low-level operations.

As shown in FIG. 1C, the processor may respond in many different ways to the execution of an instruction. An instruction may, for example, direct the processor to move, or write, one or more data values to memory 128. Alternatively an instruction may direct a processor to move, or write, one or more data values to an external target 130, such as a peripheral device, communications link, mass-storage device, or other such external target, or the instruction may direct the processor to solicit 132 input of information from external sources to memory, or direct information stored in memory 134 to external targets.

Next, as shown in FIG. 1D, the processor generally automatically fetches 136 the next instruction 138 from memory for execution. A stored-program instruction may cause the processor to fetch an instruction other than the next, sequential instruction within the currently executed object, or within another memory-resident object, such as a library routine. Thus, although instructions are generally sequentially executed, certain instructions can result in local or non-local branches to an instruction that does not follow the currently executed instruction.

There are various techniques for securing initial operation of a computer system so that the computer system reliably boots up and begins executing one or more particular stored programs. In such secure systems, the loading of information from external sources into memory is tightly and securely controlled. However, at some point, a computer system generally needs to begin executing programs that more freely interact with external entities, such as programs that import and export information to non-secure communicating entities interconnected to the computer system through communications links, or that call various library routines from unverified libraries residing on mass storage devices.

Reconsidering FIG. 1C, it is easy to understand that when a stored program interacts with external or unverified internal entitles, overall computer-system security cannot be assumed. For example, as the processor 104 executes the current instruction fetched from memory, the processor may be directed to execute instructions from another location in memory either explicitly, by the instruction fetched from the currently executed stored program, or by an asynchronous interrupt dispatched to an operating system interrupt handler, from which various different memory-resident routines may be called. Although, in the first case, the currently executing program may in good faith direct the processor to instructions stored in another memory location, that memory location may have been overwritten or otherwise modified to include functionality that the currently executed program has no intention or expectation of invoking. A mass-storage-device-resident copy of a called routine may have been overwritten inadvertently, or by a malicious local or remote entity, and then copied into the location and memory to which the currently executing program directs the processor to fetch a next instruction. Alternatively, that memory location may have been altered by a DMA-access without central processor supervision, or in the course of the processor receiving information from remote entities through a communications link. Furthermore, once a called routine begins execution, the called routine cannot safely assume that the calling routine has not been overwritten or altered prior to return of control from the called routine to the calling routine.

As shown in FIGS. 1A-D, there are many routes and events by which the contents of memory can be altered, and memory-altering events may occur at any point during the sequential execution of the instructions in a routine. Therefore, even with elaborate security mechanisms in place, a calling program cannot safely assume that an external routine or program that it calls is indeed the external program or routine that it intends to call, nor can a called routine assume that it has been called by one of the programs that the called routine is intended to be called by. In fact, in many systems, a program cannot even assume that it will remain unmolested by external entities during its own execution. For this reason, software designers and vendors, and users and manufacturers of computer systems, all recognize the need for reliable authentication techniques by which programs can ensure that they are interacting with particular external programs and routines that they are intended to interact with, and, more generally, by which a first software entity can authenticate either a second software entities or the first software entity itself.

### SUMMARY OF THE INVENTION

In various embodiments of the present invention, a first software entity, such as a program, routine, library, or module, authenticates a second software entity by accessing an authentication block from memory, validating the accessed authentication block, and comparing a value stored in the authentication block with a computable or pre-computed authentication value in order to authenticate the second software entity. In certain alternative embodiments, a program can authenticate itself at run-time. Additional embodiments of the present invention include methods for constructing and inserting authentication blocks into software entities to facilitate authentication by the authentication methods that represent embodiments of the present invention.

### BRIEF DESCRIPTION OF THE DRAWINGS

FIGS. 1A-D illustrates the basic concept of stored-program execution.

FIGS. 2A-B illustrate basic principles underlying cryptographic methodologies.

FIG. 3 illustrates a hypothetical computer-system memory in which a program and two routines are resident.

FIG. 4 shows a somewhat simpler, abstract representation of the in-memory images of program 1 and routine A of FIG. 3, providing the illustration conventions subsequently used in FIGS. 6A-B, 8A-B, and 9 to illustrate various embodiments of the present invention.

FIG. 5 illustrates construction of an authentication block that, in certain embodiments of the present invention, may be used, by a first software entity, to authenticate a second software entity.

FIGS. 6A-B illustrates inclusion of an authentication block within memory in several embodiments of the present invention.

FIG. 7 shows steps undertaken by a routine, in various embodiments of the present invention, to authenticate a different routine associated with an authentication block.

FIGS. 8A-B illustrates that a technique similar to that described with reference to FIGS. 6A-B may be employed by routine A to authenticate a program that calls routine A.

FIG. 9 illustrates use of authentication blocks in both a calling program and a called routine for bi-directional authentication.

FIG. 10 is a control-flow diagram illustrating steps taken, in various embodiments of the present invention, to prepare an authenticatable program or routine.

FIG. 11 is a control-flow diagram illustrating steps taken, in various embodiments of the present invention, to authenticate a software program or routine.

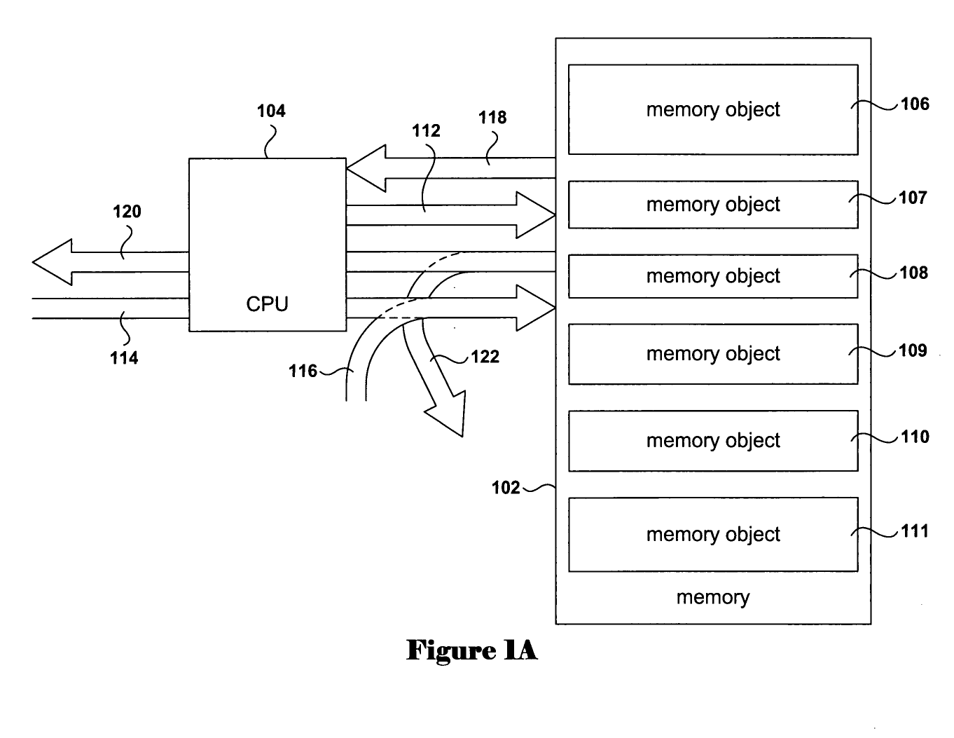

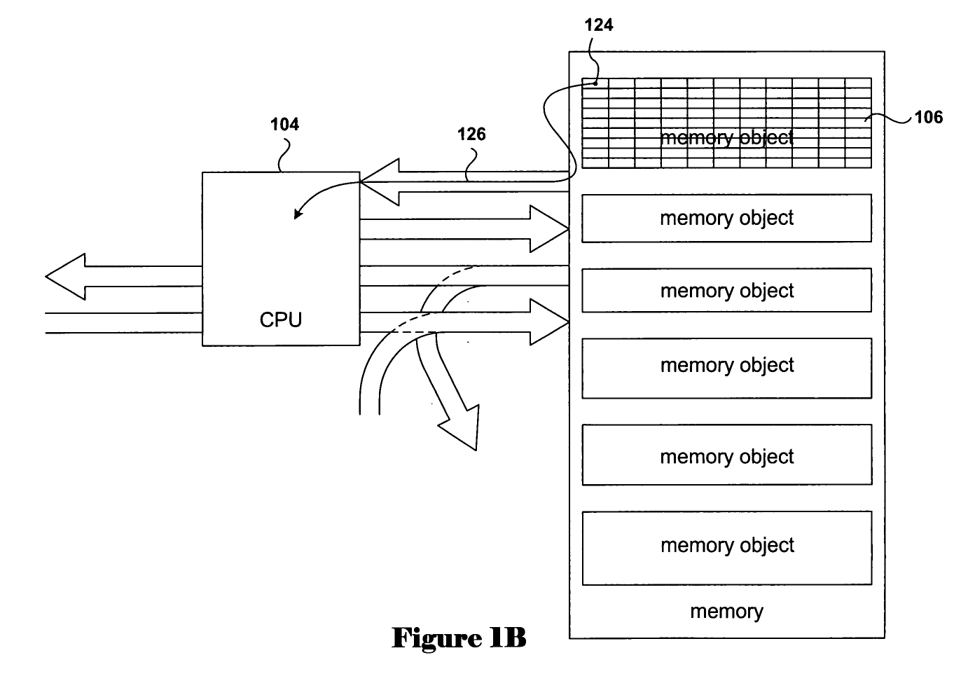

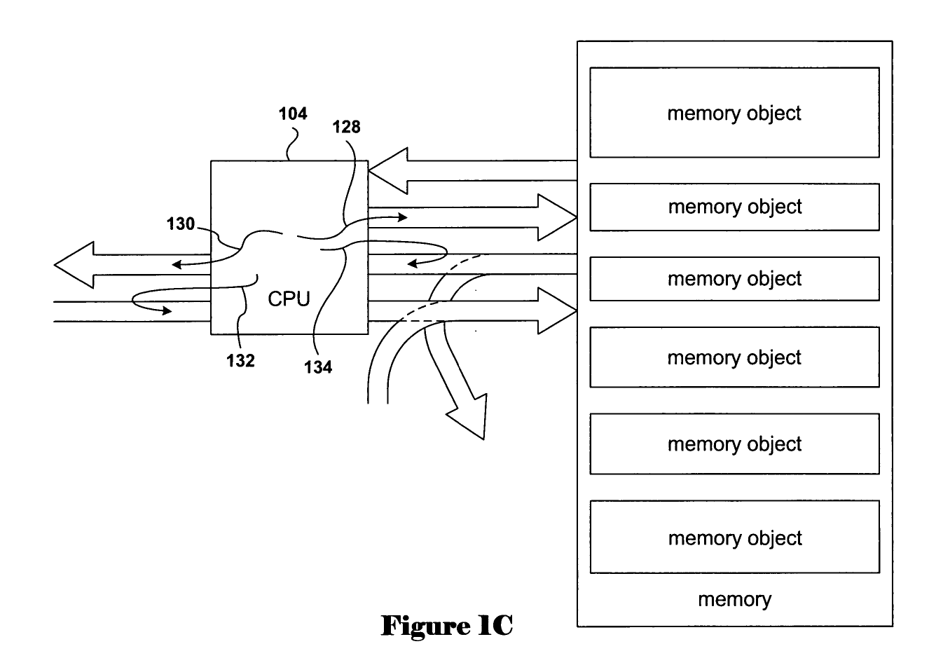

### DETAILED DESCRIPTION OF THE INVENTION

Various embodiments of the present invention employ a signed authentication block contained in memory for authenticating a software program, library, routine, or module. In certain embodiments, a cryptographic hash value is initially computed for the software module and included within the authentication block, and is subsequently re-computed by an authenticating software entity. In order to fully describe the present invention, a short overview of cryptography is provided, below. Following the first subsection, the present invention is described, in overview, with reference to a number of detailed illustrations, and then described with reference to several control-flow diagrams.

### Cryptography

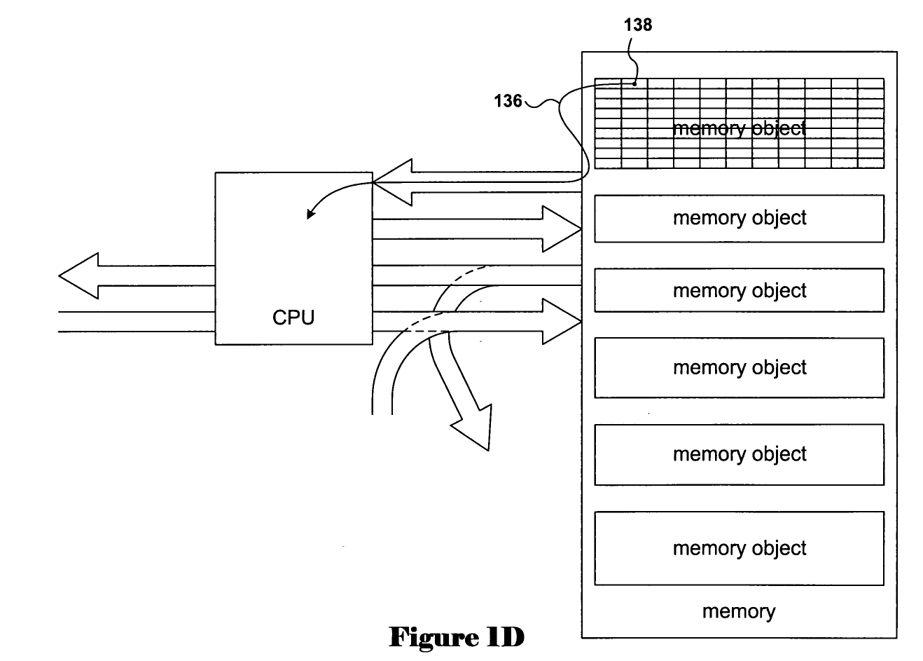

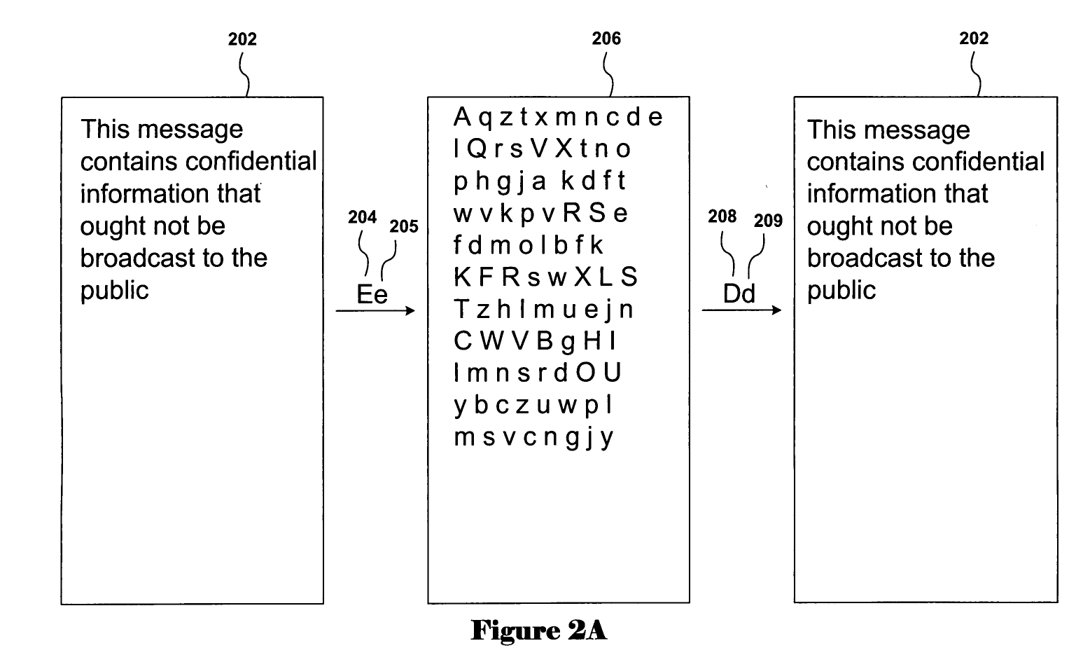

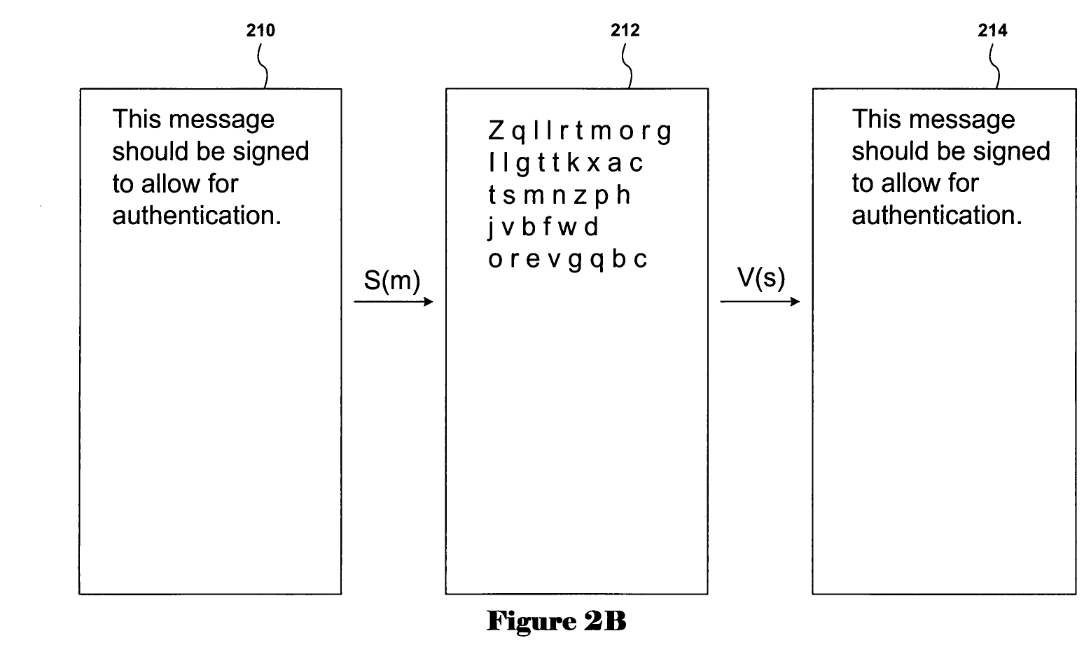

In this subsection, cryptographic methods used in various embodiments of the present invention are described. FIGS. 2A-B illustrate basic principles underlying cryptographic methodologies. In one aspect of cryptography, cryptographic methods are designed to transform plain text information into encoded information that cannot be easily decoded by unauthorized entities. For example, FIG. 2A shows a plain text message 202 that includes an English-language sentence. This plain text message can be encrypted by any of various encryption functions E 204 using a specific key 205 into a corresponding cipher text message 206 that is not readily interpretable. An authorized user is provided with a decryption function D 208 and the necessary key 209 that allows the authorized user to decrypt the cipher text message 206 back to the plain text message 202.

Public-key cryptographic methods are encryption/decryption techniques employing key pairs (e,d) having the property that, for all key pairs (e,d), it is computationally infeasible to compute d given e. Thus, the key e, called the “public key,” can be freely distributed, because the corresponding key d, called the “private key,” cannot easily be computed. A well-known example of public-key encryption is the RSA encryption scheme. Given two large prime numbers p and q, the RSA encryption and decryption keys and functions can be concisely described as follows:
n=pq
edmod(p−1)(q−1)=1
E(m)=(m^{e}modn)=c
D(c)=(c^{d}modn)=m
where n is a large integer referred to as the modulus,
e is a chosen public key, often a prime of the form 2^{x}+1, with x an integer
d is the private key corresponding to e,
E is an encryption function that encrypts a plain text message m to produce a cipher text message c, where the symbols of the plain text message are considered to form a first large number, and where the symbols of the plain text message are considered to form a first large number, and
D is a corresponding decryption function.
   Thus, a plain text message is encrypted by considering all of the numeric representations of the characters of the message to be a single large number, computing the result of raising the large number to a power equal to the public key e, and using the remainder of the division by n as the encrypted message. Decryption employs a similar process, raising the cipher-text message to a power equal to the decryption key d, then regenerating the plain text message by considering the remainder of division by n, as a string of numerically represented characters. The encrypted message is as secure as access to the decryption key d is secure.

A digital signature is a value generated from a message that can be used to authenticate the message. Generation of a digital signature involves a digital signature generation function S:
S(m)→s
where m is a message to be signed, and
s is the digital signature.
   A digital signature s is sent, along with the message m from which the digital signature is generated, to a recipient. The recipient employs a public validation function V to determine whether the digital signature authenticates the message or, in other words, whether the message was composed by the signer, and has not been modified in the interim. Thus, V can be expressed, as follows:
   V(m,s)→{true, false}
   where the result true indicates that the message m was composed by the signer who provided the digital signature s.

A digital-signature system can be generated from a reversible public-key encryption system, defined as follows:
for all m,D_{d}(Eₑ(m))=Eₑ(D_{d}(m))
For example, the above-described RSA system is reversible, and a digital-signature-generating function S can be selected as:
S=D_{d}
so that:
S(m)=D_{d}(m)=s
The validation function V can then be selected as:

$$V ( m , s ) = \{ \begin{matrix} true , if & {E}_{e} ( s ) = m \\ false & \end{matrix}$$

Thus, the techniques of the public key encryption technique can be used to generate digital signatures that can, in turn, be used by a digitally signed message recipient to verify that a message was sent by the party supplying the message m and the digital signature s. Note that, in certain applications, the digital signature s is all that needs to be communicated to a subsequent authenticator, if the authenticator can verify that the unsigned digital signature is valid by using information recovered by unsigning, or validating, the digital signature. In such cases, the validation function V can then be selected as:

$$V ( s ) = \{ \begin{matrix} true , if & ( {E}_{e} ( s ) ) [ i ] = expected value i \\ false & \end{matrix}$$

where (Eₑ(s))[i] is the value of the ith field within the message m recovered by applying the validation function to the digital signature.” In this case, the digital signature s is referred to as the “signed message.” In alternative schemes, more than a single, recovered field value may be used for validation. This latter form of validation is illustrated in FIG. 2B, showing a plain text message signed to produce a signed message 212 from which the original message 214 can be regenerated by application of the validation function. In this case, recovering a recognizable and pertinent message may be sufficient to complete the validation operation. Note that, although signing and validation appear similar to encryption and decryption, validation involves using a public key, so that the plain text version of the seemingly encrypted, signed message is available to anyone possessing the public key.

A cryptographic hash function produces a relatively small hash value, or message digest, from a large message in a way that generates large distances in hash-value space between hash values generated from message inputs relatively close together in message-input space. In other words, a small change to an input message generally produces a hash value well separated from the hash value generated for the original message, in hash-value space. One example of a cryptographic hash function widely used for this purpose is the Secure Hash Algorithm (“SHA-1”) specified by the Secure Hash Standard, available at the web site specified by the URL: http://www.itl.nist.gov/fipspubs/fip180-1.htm. The SHA-1 cryptographic hash algorithm generates a 160-bit hash value, called a message digest, from a data file of any length less than 2⁶⁴ bits in length. The SHA-1 algorithm is a cryptographic hash because it is computationally infeasible to find a message which corresponds to a given message digest, or to find two different messages which produce the same message digest. Digital signatures are often produced by signing cryptographic hash values produced from messages, rather than from the messages themselves. In this way, the digital signatures are compact, and can be computationally efficiently transmitted and validated. A cryptographic hash value is also a good choice for the value of a field within a signed message used during the validation process, as discussed above.

### Embodiments of the Present Invention

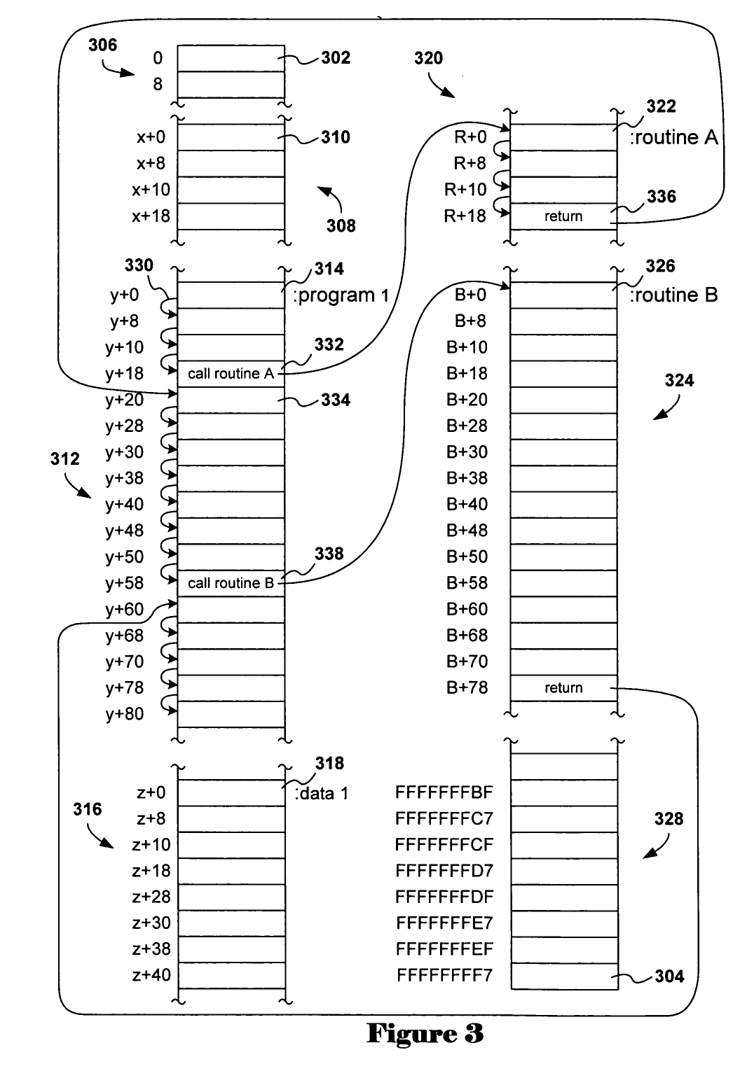

FIG. 3 illustrates a hypothetical computer-system memory in which a program and two routines are resident. The memory of a computer system can be considered to comprise a very long sequence of computer words. In FIG. 3, a memory comprising a very long sequence of over 68 billion 8-byte computer words is shown. The first byte of word 302 in the computer memory has a hexidecimal address of zero, and the final byte of the final word 304 in the computer memory has a hexidecimal address of 0×FFFFFFFFF. Of course, only a very tiny portion of the computer memory is shown in FIG. 3. The shown portions include: (1) the lowest-addressed portion of memory 306; (2) a next-highest addressed portion of memory 308 beginning with the word 310 having address X, where X stands for a memory address substantially greater than zero and substantially less than the highest memory address 0×FFFFFFFFF; (3) a next portion of memory 312 that includes the sequential instructions of a program “program 1,” beginning with an instruction at memory address Y 314; (4) a next-higher addressed portion of memory 316 beginning with the computer word 318 at address Z; (5) a next-higher address portion of memory 320 that includes the instructions of a software routine “routine A,” beginning with the computer word 322 stored at address R; (6) a next-higher address portion of memory 324 including instructions of a second routine “routine B,” beginning with the computer word 326 at memory address B; and (7) a final highest address portion of memory 328.

Different computer architectures and operating systems running on the different computer architectures partition and employ the computer memory in various different ways. As a hypothetical example, it is assumed that the operating system resides in the first portion of the hypothetical memory 306 shown in FIG. 3, that a run-time stack is contained within the second portion 308 of the memory, and that an uninitialized data block used by program 1 resides in the fourth portion of memory 316.

In FIG. 3, curved arrows, such as curved arrow 330, indicate the sequence of instructions that are executed during the course of initial execution of program 1. The first instruction 314, and the three subsequent instructions, are executed in order. The fourth instruction 332 calls, or invokes, routine A, and thus transfers control from instruction 332 to the first instruction 322 of routine A. Although not explicitly shown in FIG. 3, additional instructions are executed between the call instruction 332 and the first instruction of routine A 322 which stack various values, including a return pointer pointing to the first instruction 334 following instruction 332, into a memory location within the run-time stack in the second portion 308 of memory. The instructions of routine A are executed sequentially, ending with a final return instruction 336 that returns control to the instruction 334 following the instruction 332 that called routine A within program 1. As with the calling of routine A, additional instructions not shown in FIG. 3 may be executed to carry out the return to program 1. Program 1 sequentially executes until it calls routine B at instruction 338. Program 1 may use various static data structures and variables during execution. These static data structures and variables are stored within the uninitialized data block in the fourth portion of memory 316. A program generally includes one or more sequences of instructions followed by, or interleaved with, data blocks that the program uses for storing computed values and/or values obtained from external sources.

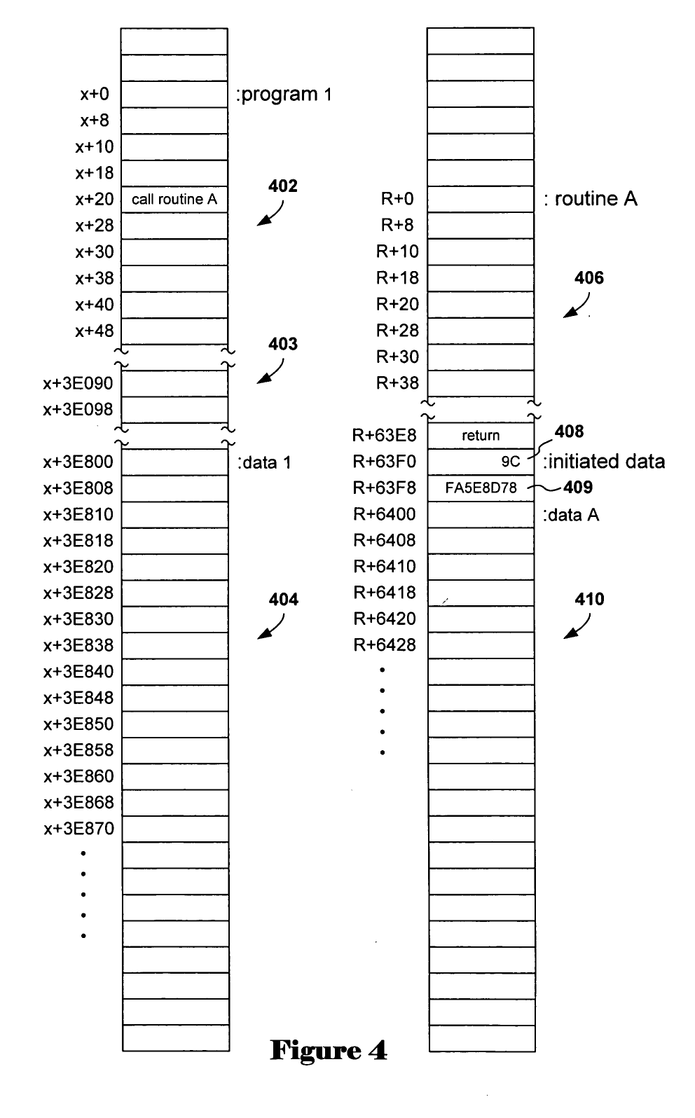

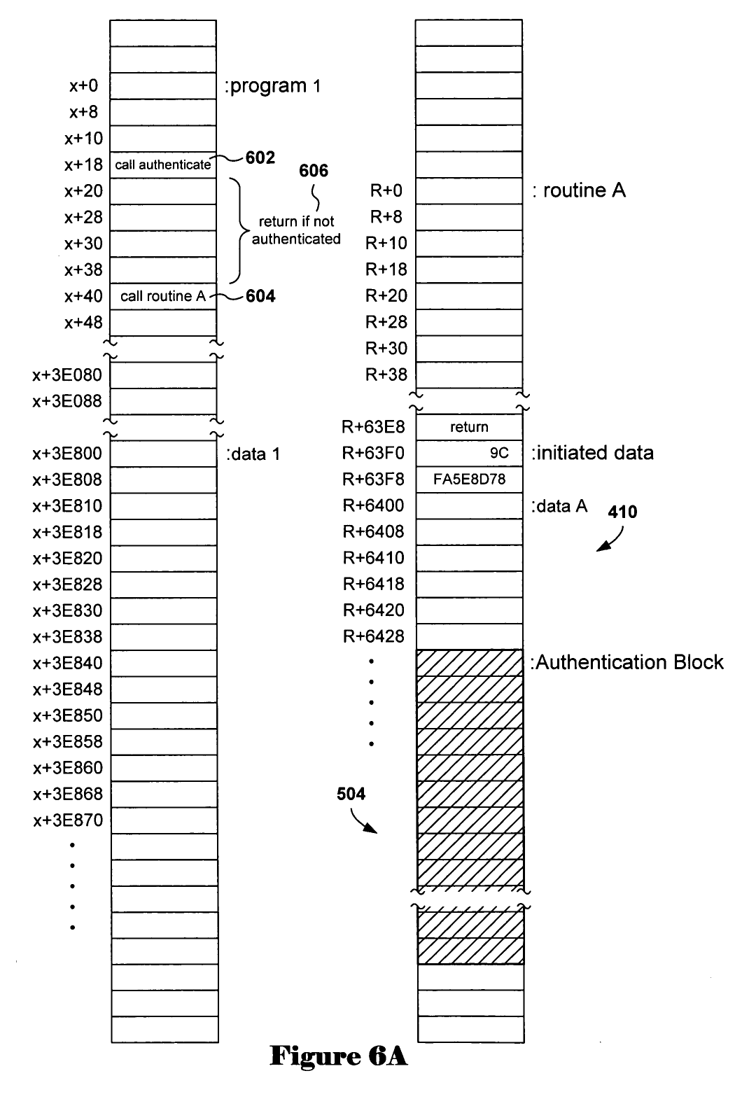

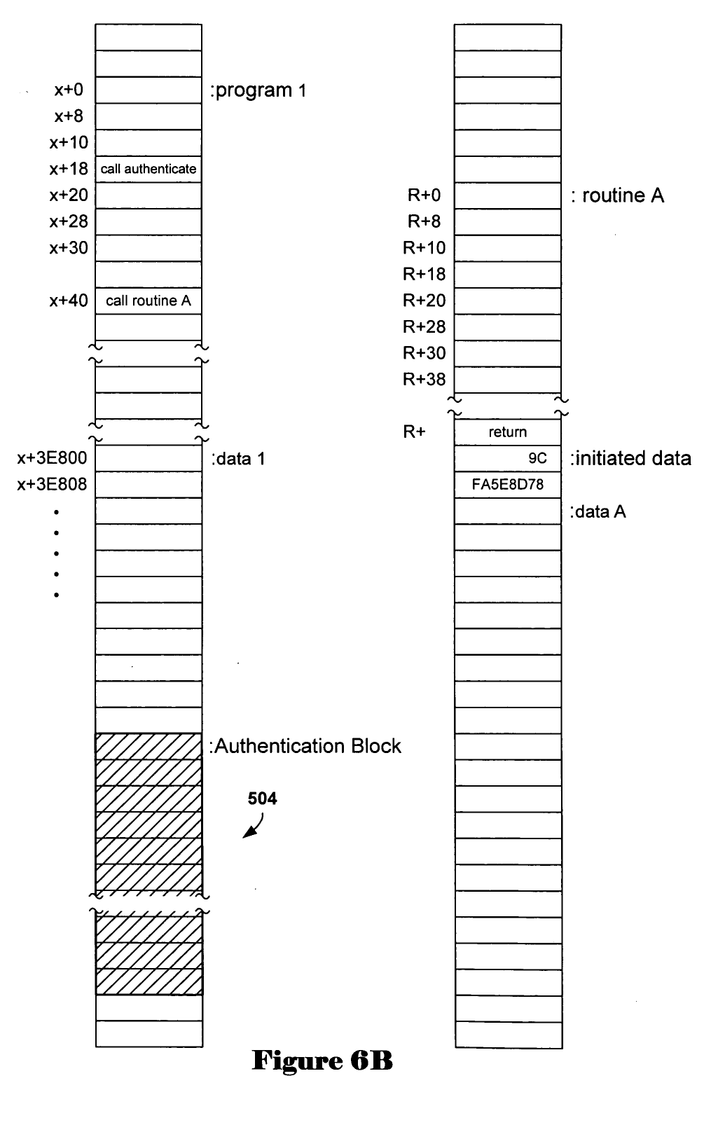

As discussed above, when program 1 calls routine A at instruction 332, program 1 cannot be sure that the memory address to which instruction fetch is directed contains the routine that program 1 expects to call. Routine A may have been modified or overlaid by any of a variety of different events. Alternatively, program 1 itself may have been modified to call a different routine. By the same token, routines A and B may have been developed only to be called by program 1, but cannot assume that they actually being called by program 1. Various embodiments of the present invention provide a mechanism by which program I can ensure that the routine called at instruction 322 is indeed an uncorrupted, in-memory image of routine A and by which routine A may determine that it has been invoked by an uncorrupted in-memory image of program 1. The same mechanisms can also be used by a program or routine to authenticate itself at any point during execution. FIG. 4 shows a somewhat simpler, abstract representation of the in-memory images of program 1 and routine A of FIG. 3, providing the illustration conventions subsequently used in FIGS. 6A-B, 8A-B, and 9 to illustrate various embodiments of the present invention. The instructions in program 1 are contained in a first contiguous set of computer words 402-403, static data structures and variables are stored and retrieved by program 1 from a data block 404, the instructions of routine A are stored in a higher-addressed portion of memory 406, with several initialized data words stored at memory locations 408-409, followed by an uninitialized data block 410.

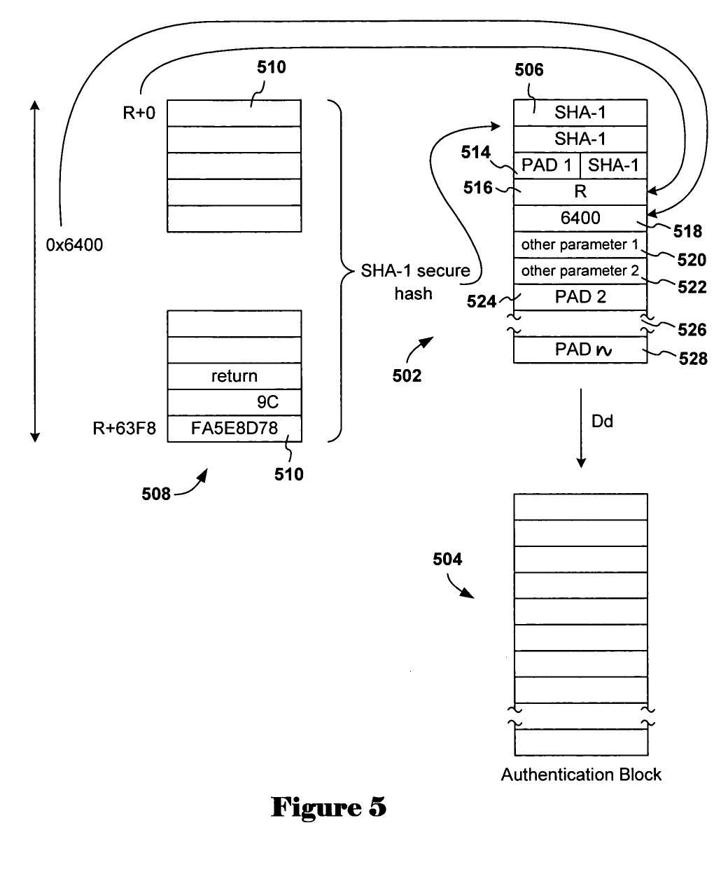

FIG. 5 illustrates construction of an authentication block that, in certain embodiments of the present invention, may be used, by a first software entity, to authenticate a second software entity. The example authentication block constructed in FIG. 5 is an authentication block that can be associated with the in-memory image of routine A, shown in FIG. 4, to allow the in-memory image of routine A to be authenticated by the calling program “program 1.” A clear text, temporary authentication block 502 is constructed to include computed and observed values related to an expected in-memory image of routine A, and then is signed using a private key d to produce a final digital signature, or signed authentication block 504. In order to create the clear text copy of the authentication block 502, computed and observed values are inserted by an authentication-block-preparation routine, an interactive authentication-block-preparation tool, or manually. In the example authentication block 502 shown in FIG. 5, a first field of the authentication block 506 is a 20-byte, or 160-bit, field containing an SHA-1 cryptographic hash value computed over the expected in-memory image of routine A 508. Note that the cryptographic hash value, in the hypothetical example, is computed over all of the instructions as well as the initialized data fields of routine A, starting with the instruction at address R 510 and ending with the initialized data value 512 stored at memory location R+63F8. In alternative embodiments, only routine instructions may be securely hashed, only a portion of the routine instructions may be securely hashed, or perhaps portions of the routine instructions and initialized data values may be re-ordered and then cryptographically hashed. The cryptographic hash simply provides a computed value that can be subsequently used to ensure that an in-memory image of routine A exactly matches the expected in-memory image of routine A 508. As discussed above, it is computationally infeasible that a useful routine different from routine A could be developed to generate the same, cryptographic hash value as that generated by routine A. The next, four-byte field of the authentication block 514 is padded with an arbitrary value. This field is optional, but, in the hypothetical embodiment, guarantees 64-bit word alignment of the following field 516. The next field 516 contains the expected address, R, for routine A, and the following field 518 contains the expected length, in bytes, of that portion of routine A that is securely hashed to generate the cryptographic hash value stored in the first field 506. Additional fields may be included 520-522 to contain additional observable or calculable values that can be used to further verify that an in-memory image corresponds to the expected in-memory image of routine A 508. For example, a field may contain the return pointer value expected to be stacked on the run-time stack when routine A is called by program 1. Another value may be an expected value of an authentication argument passed to routine A by the calling program. An almost limitless number of different possible additional observable values may be devised, based on the expected state of the computer system at the point that routine A is called. Finally, the authentication block is padded with additional fields 524-528 in order to generate a clear text copy of the authentication block of sufficient length for signing.

FIGS. 6A-B illustrates inclusion of an authentication block within memory in several embodiments of the present invention. As shown in FIG. 6A, the encrypted authentication block 504 is stored in sequential memory locations at a memory address following the uninitialized data block 410 for routine A. The authentication block may be stored in other locations within the in-memory image of routine A or of a set of routines including routine A. In other embodiments, the authentication block may be fragmented and interleaved with instructions and data locations of the in-memory image of routine A or a set of routines including routine A. The exaction location and storage method of the authentication block can be varied, as long as the program using the authentication block to authenticate routine A contains instructions to locate and, if necessary, assemble the authentication block and use the authentication block to authenticate the in-memory image of routine A. In an alternative embodiment, shown in FIG. 6B, the authentication block 504 is stored near the in-memory image of program 1, rather than near or in the in-memory image of routine A.

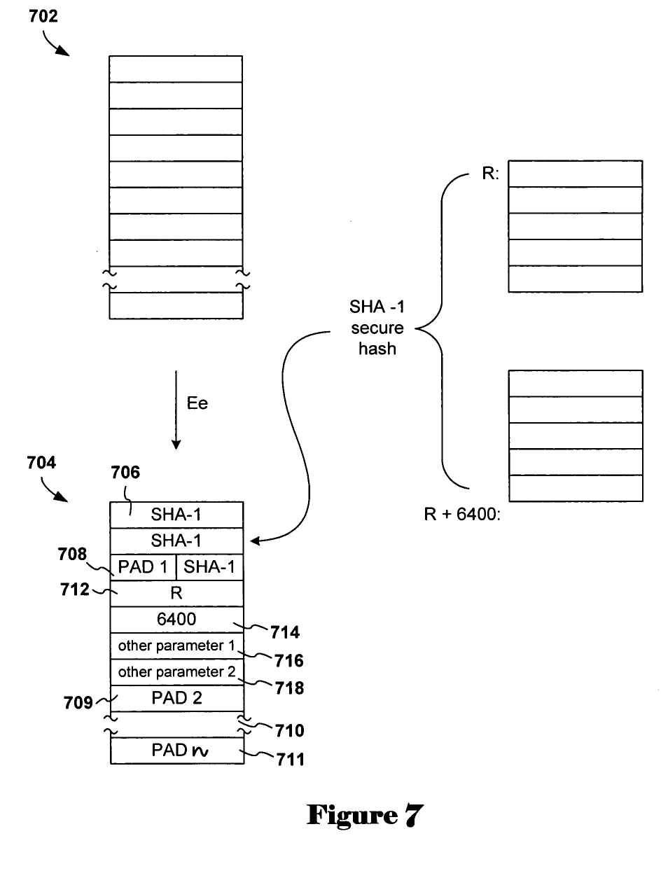

FIG. 7 shows steps undertaken by a routine, in various embodiments of the present invention, to authenticate a different routine associated with an authentication block. First, the authenticating routine needs to locate the authentication block within memory. After locating the signed authentication block 702 in memory, the authenticating routine employs a public key e to validate, or unsign, the authentication block, producing a clear text version of the authentication block 704. Then, the authenticating routine computes an authenticating value from the in-memory image of the routine to be authenticated and compares the computed value with a stored value extracted from the clear text authentication block in order to determine that the in-memory image of the routine to be authenticated exactly corresponds to the expected in-memory image for the routine. In the current example, the authenticating routine employs the SHA-1 cryptographic hash function to generate a cryptographic hash value from the in-memory image of the routine to be authenticated, and compares the computed hash value with a cryptographic hash value 706 stored within the clear text version of the authentication block.

The authenticating routine also checks to insure that the authentication block is properly formatted, and includes the expected padding values 708-711. In the current example, the authenticating routine determines the location and extent of the routine to be authenticated to which to apply the cryptographic hash function using the expected address of the routine and the length of the portion of the routine to be hashed, stored in fields 712 and 714. In addition, the authenticating routine may use additional observable values 716 and 718 to further check that the in-memory image of the routine to be called is identical to the expected in-memory image of the routine to be authenticated. For example, in the current hypothetical case, additional values may include the expected address of a return instruction within the routine to be authenticated, and the authenticating routine can access that memory address in order to determine that it contains a return instruction. The authentication steps shown in FIG. 7 are included in the authenticating program, as shown in FIG. 6, as a call to the routine “authenticate” 602, and the program then either decides to proceed with calling routine A, at instruction 604, or embarks on an error handling and error reporting strategy, in the intervening instructions 606, depending on the return value of the call to the routine “authenticate” at instruction 602. Alternatively, the authentication steps may be directly encoded into the authenticating routine, or may be carried out on behalf of the authenticating routine by a third routine, such as an operating system security routine.

As noted above, an authentication block may be fragmented and stored in various locations in memory, and therefore the authenticating routine needs to find all of the fragments and reassemble them before proceeding with authentication. As also noted above, the cryptographic hash, or other computation employed to generate a computed value from the in-memory image of a software entity to be authenticated, may be carried out over a number of separate portions of the in-memory image, and therefore the authentication block may need additional pointers and lengths to describe the locations and extents of memory to which a function needs to be applied.

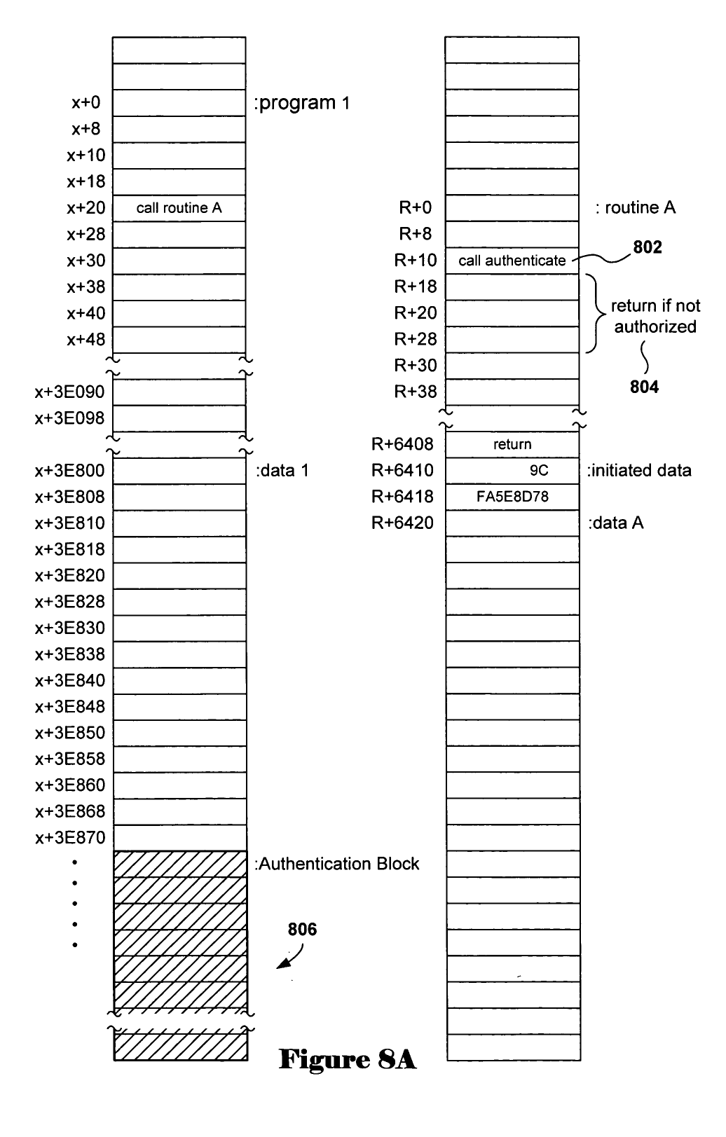

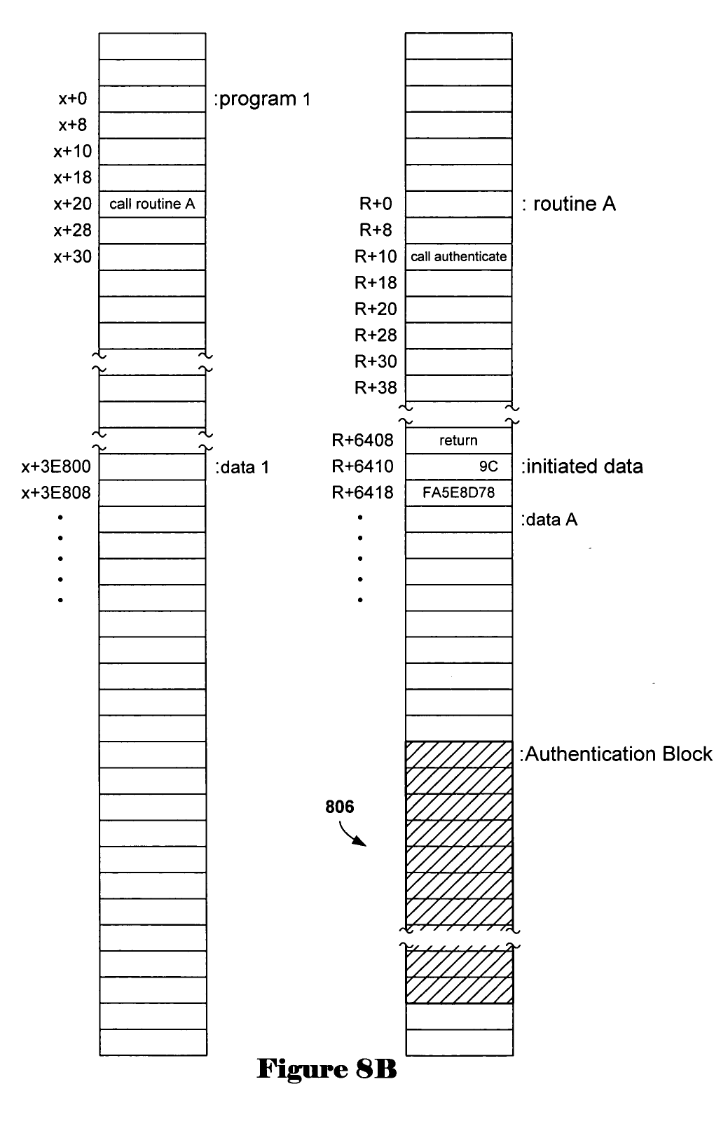

FIGS. 8A-B illustrates that a technique similar to that described with reference to FIGS. 6A-B may be employed by routine A to authenticate a program that calls routine A. As shown in FIG. 8A, routine A may include a call to an authentication routine 802, similar to the call to the authentication routine at instruction 602 in FIG. 6, and additional logic for handling the return value from the call 804, in order to employ an authentication block 806 included in, or associated with, the in-memory image of program 1. Alternatively, the authentication block 806 may be included in, or associated with, routine A, as shown in FIG. 8B. Authentication of a calling program is nearly identical with authentication of a program or routine to be called, with the exception that different observables may be used for further authentication of the calling program.

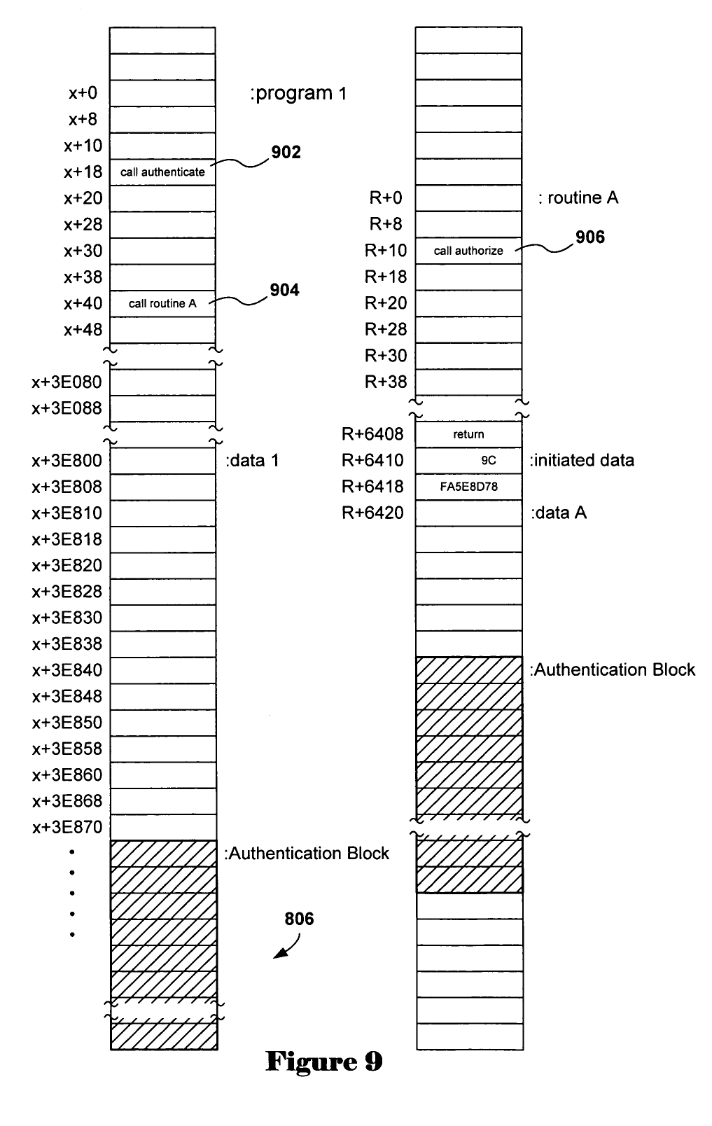

FIG. 9 illustrates use of authentication blocks in both the calling program and the called routine for bi-directional authentication. Thus, as shown in FIG. 9, the calling program may authenticate 902 the program which it intends to call 904, and the called program may authenticate 906 the calling program. Additional embodiments are also possible. In the examples shown in FIGS. 6 and 8-9, the called routine expects to be called by a single program. However, it may be the case that a library routine is developed to be called by any number of different programs that may be resident at different locations in memory at different times. In such cases, the called routine may include a separate authentication block for each possible calling program, and may use either the stack return value or arguments passed to the called routine by the calling routine in order to locate and compute an authentication value based on the calling program. Similarly, a calling program may expect to call a number of different routines, each of which will seek to authenticate the calling program, and the calling program therefore may include a separate authentication block for each routine that the calling program calls. Of course, each routine needs to be able to locate the corresponding authentication block. In the described embodiments, authentication blocks are prepared by program and routine developers, either manually, semi-automatically, or automatically, and are packaged so that the authentication blocks can be retrieved from the in-memory image of the program or routine and validated. Therefore, the routine or program developer uses a private asymmetrical key to sign the authentication block, and furnishes a public key to the developers of programs and routines that seek to authenticate the program or routine using the authentication block. In alternative embodiments, different types of cryptographic techniques may be employed by the program or routine developer to cryptographically sign the authentication block and to generate one or more computed authentication values. Finally, a program may include an authentication block that allows the program to authenticate itself at different points during execution, to ensure that it has not been modified by external entities or inadvertently by itself.

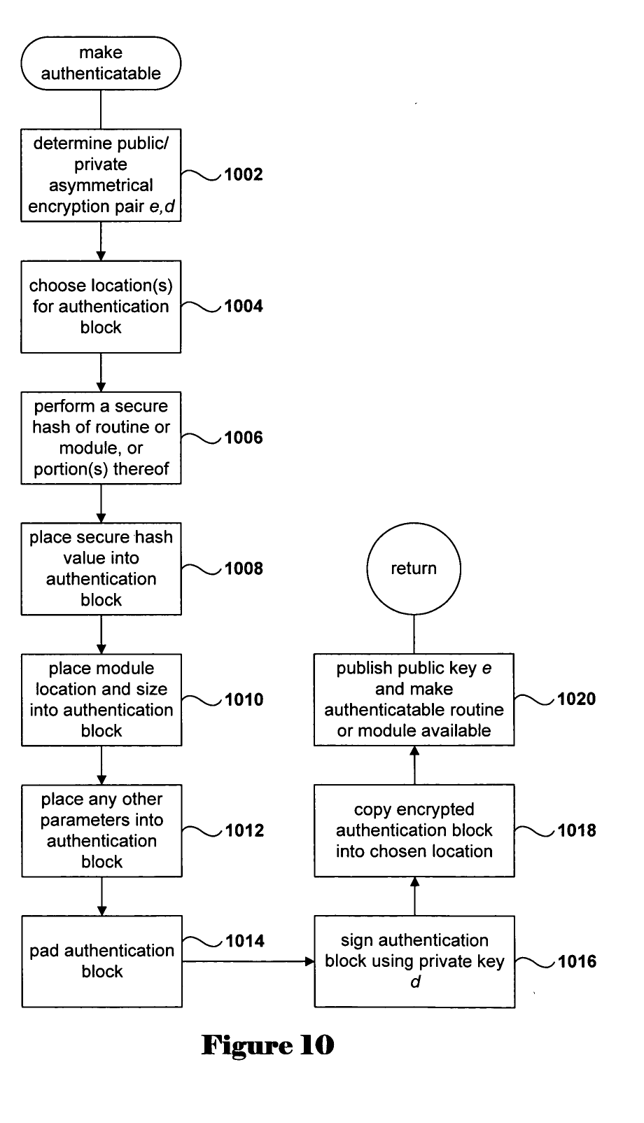

FIG. 10 is a control-flow diagram illustrating steps taken, in various embodiments of the present invention, to prepare an authenticatable software entity. In step 1002, the developer chooses, in certain embodiments, a public/private asymmetrical encryption-key pair (e,d). In general, a developer may use the same encryption-key pair for many different software entities. Next, in step 1004, the developer chooses a location for the authentication block in an expected in-memory image of the program or routine, or a set of programs or routines including the routine, or may, in alternate embodiment, may choose to provide the authentication block for inclusion in different software entities that subsequently authenticate the authenticatable software entity. As discussed above, different types of cryptographic techniques may be used for signing and validation, other than use of an asymmetrical encryption key pair, and an authentication block may be stored in a fragmented and re-ordered form, or in other ways to further complicate the task of a malicious developer that would seek to make a maliciously developed routine authenticatable by these techniques. In step 1006, the developer carries out a cryptographic hash of the program or routine, or, as discussed above, a portion or several portions of the program or routine in order to produce a cryptographic hash value. Next, in step 1008, the developer places the cryptographic hash value into a temporary, clear text version of the authentication block. In step 1010, the developer places additional values into the clear text, temporary version of the authentication block, including, in the described embodiment, an expected location and size of the program or routine, or a portion of the program or routine, that an authenticating program or routine can securely hash in order to compute a cryptographic hash value to compare with the cryptographic hash value computed in step 1006. In step 1012, the developer places any other observable or calculated parameters into the clear text version of the authentication block. In step 1014, the developer appropriately pads and formats the clear text, temporary version of the authentication block, and in step 1016, the developer signs the clear text, temporary version of the authentication block using the private key d in order to produce a signed version of the authentication block which is copied, in step 1018, into the location chosen in step 1004 or provided to developers of authenticating programs, in alternative embodiments. Finally, the developer makes the public key e and the authenticatable routine available to the developers of calling programs or routines in step 1020. Making the authenticatable program or routine available may include providing additional information, such as the contents and format of the authentication block, and any algorithms or procedures needed to find and extract run-time information, and to compute values, in order to authenticate the in-memory image of the authenticatable routine at run time using the decrypted contents of the authentication block.

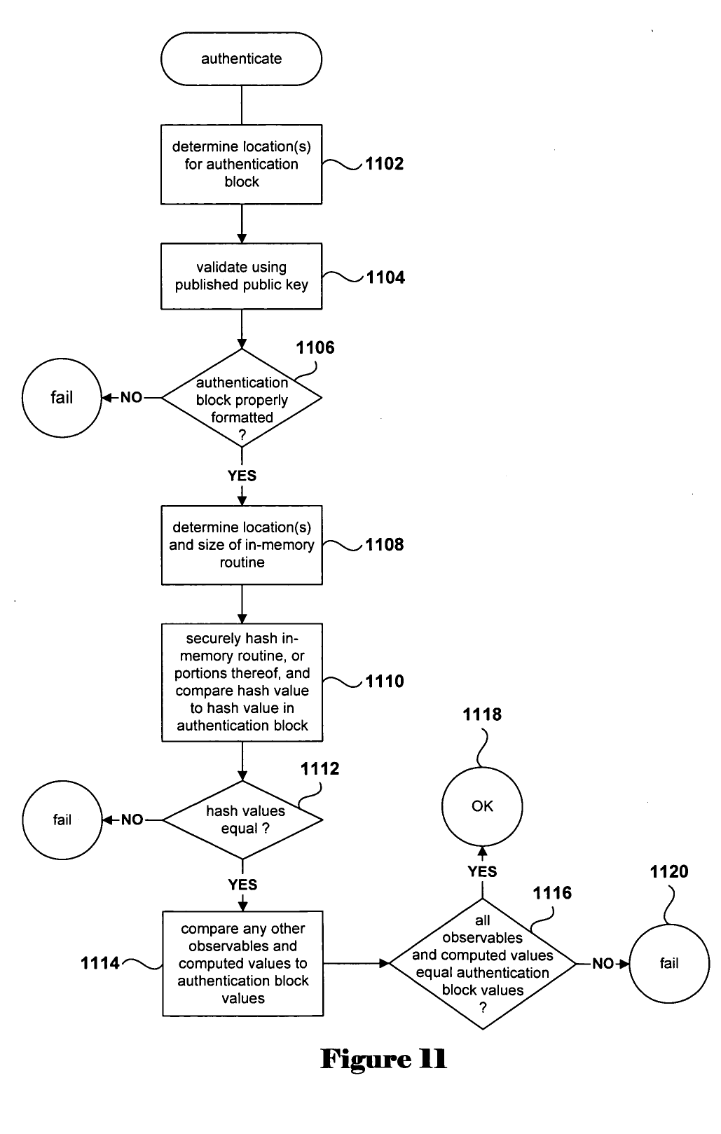

FIG. 11 is a control-flow diagram illustrating steps taken, in various embodiments of the present invention, to authenticate a software program or routine. In step 1102, the authenticating routine determines the location of an appropriate authentication block in memory. As discussed above, an authenticatable program or routine, or authenticating program or routine, may include many different authentication blocks, and the authentication blocks may need to be extracted according to an extraction algorithm, depending on the particular embodiment of the present invention. In many embodiments, the authentication block will appear at a standard location known to the developer of the authenticating program or routine. Next, in step 1004, the authenticating routine validates the located authentication block using a published public key, in many embodiments a public, asymmetric encryption key, to produce a clear text copy of the authentication block. As discussed above, an asymmetric public/private encryption key pair is commonly employed for signing and validating an authentication block, but other cryptographic techniques may also be employed in order to produce a signed authentication block by the developer of the authenticatable routine. Next, in step 1106, the authenticating routine determines whether the clear text, validated version of the extracted authentication block is properly formatted, including containing proper padding values, having a proper length, and other such characteristics. If the authentication block is not properly formatted, then the authenticate routine returns failure. Otherwise, in step 1108, the authenticating routine determines the location and size of that portion of the routine on which to compute an authentication value. As discussed above, the entire routine may be used to compute the authentication value, a portion may be used, or discrete portions may be combined and then used to produce the authentication value. If the computed value is computed over multiple, discrete memory regions, then additional location and extent information may need to be extracted from the authentication block, or an agreed algorithm may need to be employed to find all of the discrete memory regions. In the above described embodiments, a cryptographic hash function is employed to produce a cryptographic hash value which is then compared with a stored hash value within the clear text version of the authentication block in step 1110. If the computed hash value and the stored hash values are not equal, as determined in step 1112, then the authentication routine returns failure. Otherwise, in step 1114, the authenticating routine compares any other observables or calculated values included in the authentication block to observed characteristics of, and computed values based on, the in-memory image of the program or routine to be authenticated. If all the observed and computed values are equal to the corresponding values stored in the authentication block, as determined in step 1116, then the authenticating routine returns success in step 1118. Otherwise, the authenticate routine returns failure in step 1120.

Although the present invention has been described in terms of a particular embodiment, it is not intended that the invention be limited to this embodiment. Modifications within the spirit of the invention will be apparent to those skilled in the art. For example, as discussed above, the process of making a program, routine, or module authenticatable may be fully automated, may be carried out manually by developers of the authenticatable software entity, or may be conducted by developers using authentication-block-preparation programs and systems. Fully automated authentication routines may be employed by authenticating programs or routines in order to authenticate authenticatable routines, as discussed above. Alternatively, manual or semi-automated authentication may be performed by systems developers and during the course of system debugging and verification. As discussed above, embodiments of the present invention depend on inclusion of authentication blocks within the in-memory images of authenticatable routines, programs, or modules. Authentication blocks may be stored in sequential memory locations, may be scattered throughout the image, or may be included in other, known memory locations. It is important only that the authenticating program or routine contains instructions to locate, assemble, and validate, or unsign, the authentication block at run time. For example, in alternative embodiments, the authentication block may be passed as an argument to the authenticating program. Various embodiments of the present invention depend on digitally signing of the authentication block by the developer of the authenticatable program, routine, or module. The described embodiments employ public/private asymmetric key encryption technique for digitally signing the authentication block, but other cryptographic methods may be used. It is important only that the authenticating program or routine employs a technique to verify that the authentication block obtained from the in-memory image of an authenticatable routine or program is authentic. As discussed above, an authentication block needs to include an authentication value that the authenticating program or routine can compute from the in-memory image of the authenticatable program, routine, or module. In the above-described embodiments, the authentication value is a cryptographic hash value. Many other types of authentication values can be imagined. For example, other types of cryptographic signing and hashing operations may be employed, analytical mathematical functions may be employed, or other techniques may be employed that produce a different computed value for similar, but different programs and routines, so that a malicious developer cannot construct a substitute routine that would generate the same computed value as a legitimate routine that the malicious developer seeks to overwrite or supplant in a computer system. As discussed above, many different types of additional authentication values and observable characteristics and parameters of an in-memory image of an authenticatable program, routine, or module may be additionally included in the authentication block to provide even more thorough authentication. Above-discussed examples include return pointer values, locations of particular instructions, computed values, such as the number of a particular type of instructions in the in-memory image, initialized data values included in the in-memory image, passed authentication parameters, and various values that can be gleaned from the overall state of the computer system. Individual routines, programs, software libraries, modules, or portions of routines my be authenticated using an authentication block.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for authenticating a software entity comprising:
locating a signed authentication block in a memory of a computer system;
employing a cryptographic technique to verify that the signed authentication block is authentic;
computing an authentication value from an in-memory image of the software entity; and
comparing the computed authentication value with an authentication value stored in the authentication block to determine whether or not the in-memory image of the software entity is identical to an expected in-memory image for the software entity.

2. The method of claim 1 wherein locating a signed authentication block in the memory further includes one of:
locating the signed authentication block in contiguous memory locations within the in-memory image of the software entity;
locating the signed authentication block in contiguous memory locations within an authenticating software entity; and
locating the signed authentication block in contiguous memory locations at a previously established memory location;
locating fragments of the signed authentication block in a number of previously established memory locations and assembling the signed authentication block from the located fragments in a number of contiguous memory locations.

3. The method of claim 1 wherein locating a signed authentication block in the memory further includes:
locating the signed authentication block by computing one or more memory locations and extents according to a previously established process.

4. The method of claim 1 wherein locating a signed authentication block in the memory further includes:
locating fragments of the signed authentication block in a number of previously established memory locations and assembling the signed authentication block from the located fragments in a number of contiguous memory locations.

5. The method of claim 1 wherein employing a cryptographic technique to verify that the signed authentication block is authentic further includes:
validating the authentication block using a public key and checking that the format of the validated authentication block corresponds to an expected authentication block format.

6. The method of claim 1 wherein employing a cryptographic technique to verify that the signed authentication block is authentic further includes:
validating the authentication block using a public key and checking that values included in the authentication block are identical to expected values.

7. The method of claim 1 wherein computing an authentication value from the in-memory image of the software entity further includes:
computing a cryptographic hash value using a cryptographic hash function.

8. The method of claim 7 wherein the cryptographic hash value is computed over the entire in-memory image of the software entity.

9. The method of claim 7 wherein the cryptographic hash value is computed over one or more portions of the in-memory image of the software entity.

10. The method of claim 1 further including:
comparing an additional computed authentication value with an additional computed authentication value stored in the authentication block to determine whether or not the in-memory image of the software entity is identical to an expected in-memory image for the software entity.

11. The method of claim 1 further including:
comparing an additional authentication value stored in the authentication block with a value observed from the memory to determine whether or not the in-memory image of the software entity is identical to an expected in-memory image for the software entity.

12. The method of claim 11 wherein the additional computed value is one of:
a stacked return pointer value;
a passed argument; and
an address of a particular instruction.

13. The method of claim 1 wherein the software entity is one of:
a program or routine called by a calling program or routine;
a program or routine that calls a different program or routine;
a library routine;
a software module; and
a program that seeks to authenticate itself.

14. Computer instructions encoded in a computer readable medium for carrying out the method of claim 1.

15. A method for constructing an authentication block used to authenticate the in-memory image of a software entity, the method comprising:
determining a location for the authentication block;
preparing a clear text temporary copy of the authentication block to include a computed value that can be subsequently calculated by a program based on the in-memory image of the software entity;
signing the clear text temporary copy of the authentication block to produce a signed authentication block; and
copying the signed authentication block into code from which the authentication block is subsequently copied into the determined location.

16. The method of claim 15 wherein determining a location for the authentication block further includes:
determining a memory location in or near the in-memory image of the software entity that can be later determined by an authorizing program in order to access the signed authentication block.

17. The method of claim 15 wherein determining a location for the authentication block further includes:
determining a number of memory locations in or near the in-memory image of the software entity that can be later determined by an authorizing program in order to access portions of the signed authentication block and assemble the signed authentication block.

18. The method of claim 15 wherein determining a location for the authentication block further includes:
determining a memory location in or near the in-memory image of an authenticating software entity that can be later determined by an authorizing program in order to access the signed authentication block.

19. The method of claim 15 wherein determining a location for the authentication block further includes:
determining a number of memory locations in or near the in-memory image of an authenticating software entity that can be later determined by an authorizing program in order to access portions of the signed authentication block and assemble the signed authentication block.

20. The method of claim 15 wherein the computed value is a cryptographic hash value generated by a cryptographic hash function on the expected in-memory image of the software entity.

21. The method of claim 15 wherein the computed value is a cryptographic hash value generated by a cryptographic hash function on one or more portions of the expected in-memory image of the software entity.

22. The method of claim 15 wherein signing the clear text temporary copy of the authentication block to produce a signed authentication block further includes:
signing the clear text authentication block using a private key.

23. The method of claim 15 further including:
including an additional authentication value into the clear text authentication block.

24. The method of claim 23 wherein the additional authentication value is one of:
a return pointer value;
the memory address of a particular type of instruction;
a passed argument;
a size of a portion of the software entity from which the computed value is generated;
a memory address for the start of the in-memory image of the software entity; and
any value that can be computed from the memory at the time that the authentication block is accessed by an authenticating routine.

25. A software entity including an authentication block prepared by the method of claim 15.

26. An authentication block prepared by the method of claim 15 stored in a computer readable medium.
